(19) United States
(12) Patent Application Publication
(10) Pub. No.: US 2003/0006570 A1
(43) Pub. Date: Jan. 9, 2003

(54) Three-wheeled wheel barrow

(76) Inventor: Howard Lee Baker, Rocky Mount, NC (US)

Correspondence Address: WILLIAM P. SMITH, 223 FOXBURG DRIVE, PITTSBURGH, PA, 15205, US

(21) Appl. No.: 09/900,182

(22) Filed: Jul. 9, 2001

(51) Int. Cl. B62B 1/10; B62B 1/18

(52) U.S. Cl. 280/47.17; 280/47.34

(57) ABSTRACT

A wheel barrow having three wheels is disclosed. A forward wheel is positioned adjacent the point of intersection between two convergent longitudinal frame members, and a pair of rearward wheels are disposed intermediately of the forward and rear ends of the longitudinal frame members. Frame members provide a support carriage for a container. Rear wheels are connected by an axle, and rear axle is connected at each end to frame members by downwardly depending bracket members. The wheels enable the operator to use the wheelbarrow without having to lift up to move the wheel barrow. The wheelbarrow can be moved merely by pushing the rearwardly extending, divergent frame members.

### FIELD OF INVENTION

This invention relates to wheel barrows and in particular relates to an improved wheel barrow having three wheels.

### RELATED APPLICATIONS

This invention was disclosed in Disclosure Document No. 471542 filed Mar. 27, 2000.

### BACKGROUND OF THE INVENTION

Wheel barrows are well-known in the prior art. Implements used in forming gardening in general manual labor jobs, wheel barrows are tremendously useful for transporting tools, debris, brush, vegetation, and construction material such as cement and concrete. Single-wheeled wheel barrows with a pair of rear legs are common known.

U.S. Pat. No. 5,758,887 issued in the name of Bapst discloses a wheel barrow with an improved wheel assembly. A pair of wheels are secured to an axle, which is in turn fastened to front legs. A pair of rear legs depend downwardly of the container.

U.S. Pat. No. 5,033,760 issued in the name of Evans, discloses a method of converting a single-wheeled wheel barrow to a two wheeled wheel barrow whereby an extended axle is attached to the structural longerons and wheels of fixed laterally outside each longerons.

### SUMMARY OF INVENTION

Accordingly, an improved wheel barrow having a single front wheel and a pair of wheels mounted laterally on a common axle rearwardly of the front wheel is described. A hollow container portion has vertical sides and a bottom panel, open upwardly; to receive material. Two longitudinal frame members are disposed beneath and attached to the container portion. The two frame members each have a first and second end. A forward axle and a rear axle are connected from underneath to the pair of frame members laterally. First and second rear axle support brackets depend from the first and second frame members respectively, positioned intermediate of each said first and second ends. The forward axle extends laterally, adjacent to said first end of each of the frame members and is rotatably connected thereto. A front wheel is rotatably attached to the front axle and positioned centrally of the first end of each frame member. A rear axle extends laterally between the first and second rear axle support brackets. The rear axle has a pair of wheels rotatably attached at either of the first or second ends of the rear axle for translation of rotational movement to linear movement by frictional engagement of the wheels with the ground, when said apparatus is pushed or pulled by an operator applying a forward or reverse force. It is an object of the present invention to provide a wheel barrow having one front wheel and a pair of large wheels continuing to raise the handles of the wheel barrow to a convenient, comfortable height for an adult individual.

It is another object of the present invention to provide a wheel barrow that eliminates the need for the user to bend to lift a wheel barrow by allowing the user to simply push the wheeled apparatus rather than raising the rear legs off of the ground as required by existing wheel barrows.

Yet another object of the present invention is to provide a more stable wheel barrow having larger wheel rears to increase balance and stability.

### DESCRIPTION OF DRAWINGS

FIG. 1 is a top perspective view of the three-wheeled wheel barrow;

FIG. 2 is a side elevational view, illustrating proportional relationship of the wheel barrow with a human being; and

FIG. 3 is a bottom plan view.

### DETAILED DESCRIPTION OF THE INVENTION

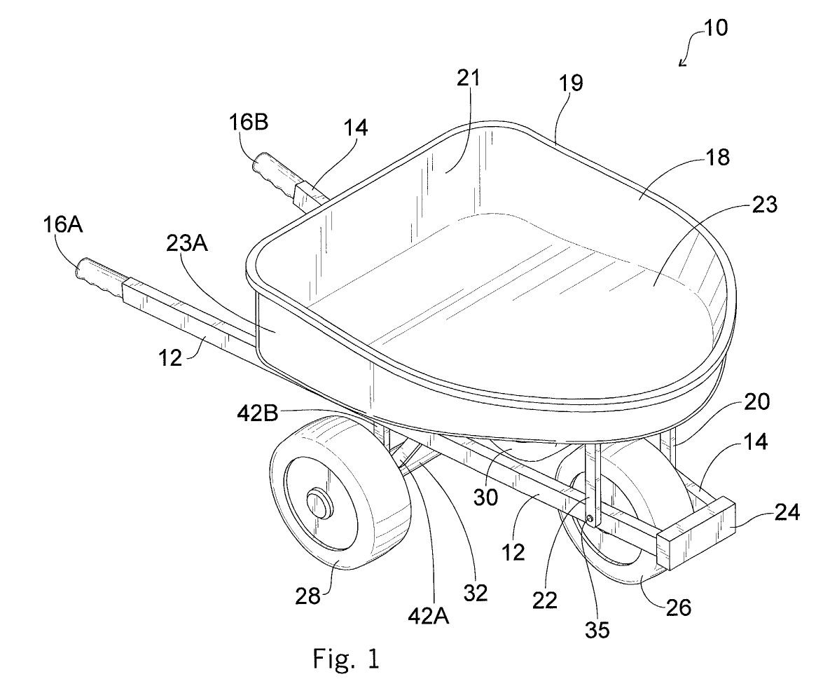

Referring first to FIG. 1, a three-wheeled wheel barrow is generally designated as 10. Frame members 12, 14 are comprised OF rectangular bars which extend longitudinally from back to front of barrow portion 18. Said frame members 12, 14 are coplanar and convergent towards the forward portion of barrow 18. Frame members 12, 14 extend underneath the barrow 18 providing support for resting barrow portion 18 thereon. Grip means 16a and 16b are provided at the divergent ends of frame members 12, 14, for grasping and manipulating the wheel barrow 10.

At the convergent end of the frame members 12, 14 there is a cross connection member 24 which connects first frame member 12 to second frame member 14. Adjacent and just behind cross connection 24 is forward wheel 26. Forward wheel 26 is rotatably connected to frame members 12, 14 through forward axle 35. Another rear axle 32 is disposed rearwardly of forward wheel 26, and connects rear wheels 28, 30. Rear axle 32 traverses horizontally beneath wheel barrow 28. Axle 32 is connected to the frame member 12 by means of first angle leg 42a and second angle leg 42b. Angle leg 42b extends straight up from axle 32 and angle leg 42a extends at an oblique angle to connect to frame member 12 between forward axle 35 and rear axle 32 along frame member 12. Two vertically extending forward leg member 20,22 connect to forward axle 35 to the bottom portion 40 of bottom pan 23. Bottom portion 40 is the front portion of barrow 18, which projects upward at an angle from coplanar members 12, 14 up and projecting overtop of forward wheel 26. Leg members 20,22 to attached to bottom portion 40 to maintain a spacing and support barrow 28.

Top edge 19 defines the rim of barrow 18 and is a parabolic-shaped forward edge and terminates in rear wall 21 with a back portion. Twenty-one (21) connecting the terminus parabola.

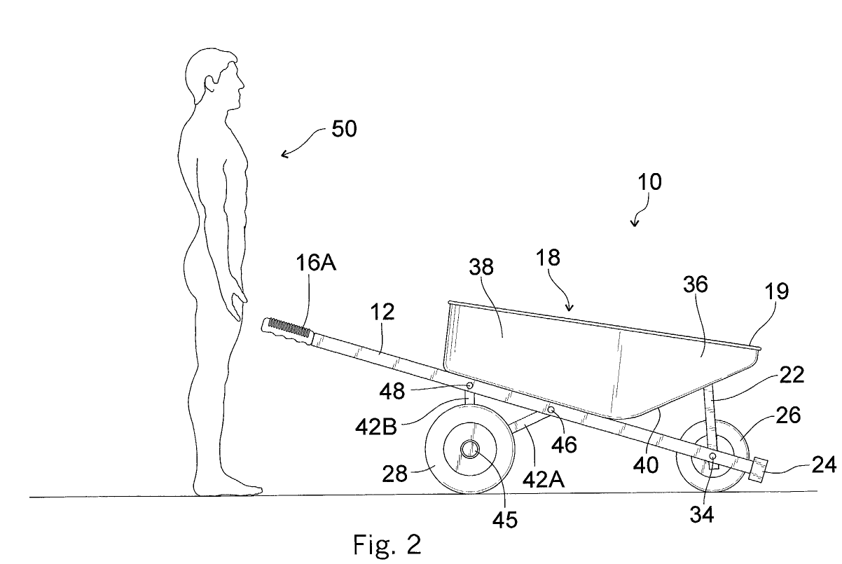

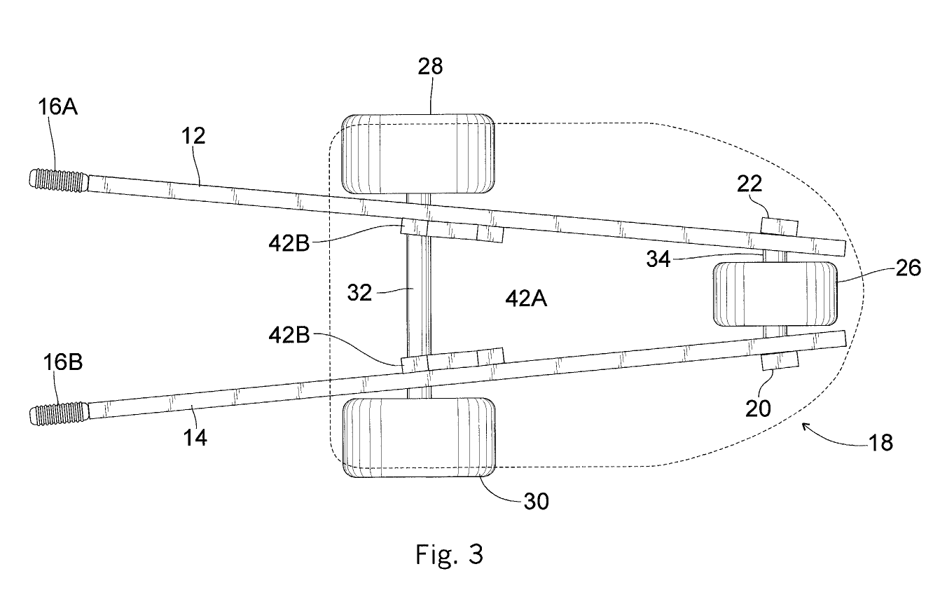

Referring next to FIG. 2, a silhouette 50 of a human being is shown indicating the approximate relationship of the hand height to the handle gripping members 16a with an average sized human being. The frame member 12 extends downwardly at an angle towards the ground from the rear, terminating at cross connection member 24. Axle 34 is shown projecting through the side of frame member 12. Rear wheel 28 is shown as slightly larger than front wheel 26, to provide additional stability and support. A bearing 45 is shown in wheel 28, which permits rear axle 32 to rotate. Angle legs 42a and 42b are shown extending upwards from rear axle 32 to connect to frame member 12 at bolts 48 and 46. Referring to FIG. 3, the bottom plan view shows the rear wheels 28,30 connected by way of rear axle 32 which extends through vertical legs 44a and 44b. Likewise, forward axle 34 is shown extending through forward wheel 26 and projecting it to vertical member 22 and 20.

Accordingly, the hollow container defined by top edge 19 and walls 23a, 38, 36, and 21 comprises the barrow 18 for holding a quantity of material. As is evident from FIG. 2, the wheel barrow 10 is free standing, and does not require an individual to balance it when sitting on a generally flat surface. In order to move the wheel barrow, the individual needs merely to grip handles 16a, 16b and push forward or pull backwards to commence the wheels to turn. What is not required is that the person exert a vertical force at the handle grips 16a in order to raise rear wheels 28, 30 off of the ground, as would be required with a traditional wheel barrow without rear wheels 28, 30. The typical wheel barrow would simply have angular legs for vertical support without rotational means that would permit forward and backward movement without lifting. Aternately, longitudinal frame members also may have an upward curvature (not shown) adjacent said rear portion terminus, where the grip means 16a, 16b would extend nearly vertically, to allow the operator to simply grasp and push, thereby eliminating any lifting.

However, it should be noted if lifting is optionally desired, the forward cross connecting member 24 provides in effect a braking means, which when the frame members are raised from the rear, it will impinge the ground, causing the wheel barrow to stop and if further vertical force is applied, tilt forward to dump the contents of barrow 18.

According to the provisions of the patent statutes, I have explained the principle, preferred constructed, and mode of operation of my invention, and have illustrated and described what I know consider to represent its best embodiments. However, it should be understood that within the scope of the appended claims, the invention may be practiced, otherwise that specifically illustrated and described.

I claim

1. In a wheel barrow apparatus, the improvement comprising:
a hollow container portion having vertical sides and a bottom panel, open upwardly;
first and second longitudinal frame members disposed beneath and attached to said container portion;
said frame members each having a first and second end;
a forward axle and a rear axle connected from underneath to said pair of frame members laterally;
first and second rear axle support brackets depending from said first and second frame members respectively, positioned intermediate of each said first and second ends;
said forward axle extending laterally adjacent to said first end of each said frame members and rotatably connected thereto;
a front wheel rotatably attached to said front axle and positioned centrally of said first end of each said frame members;
a rear axle extending laterally between said first and second rear axle support brackets;
said rear axle having first and second ends, and a pair of wheels rotatably attached at either said first or second ends of said rear axle for translation of rotational movement to linear movement by frictional engagement of said wheels with the ground, when said apparatus is pushed or pulled by an operator applying a forward or reverse force, respectively.

2. The improved wheelbarrow device as set forth in claim 1, wherein said first and second longitudinal members having a gripping means attached to said second end.

3. The improved wheelbarrow device as set forth in claim 1, wherein said container portion having a parabolically shaped forward perimeter, for directing the load toward the center line of said container when dumping.

4. The improved wheelbarrow device as set forth in claim 1, wherein said wheels each having a friction reducing bearing mean connecting said wheel to said axle to reduce friction between the wheel and frame portion when rotating relative to each other.

5. The improved wheelbarrow device as set forth in claim 1, wherein said longitudinal frame members also having an upward curvature adjacent said rear portion terminus.

6. A wheelbarrow comprising:
a container attached to first and second longitudinal frame members;
each said frame member having a rear and a forward end, and angle brackets attached intermediately of said rear and forward end, and depending therefrom;
a pair of upwardly extending legs adjacent said forward end of each frame member;
a rear axle rod member having two ends, said ends rotatably attached to said angle brackets;
a pair of rear wheels rotatably attached at opposing ends of said rear axle rod member;
a forward axle rod member rotatably connected laterally of said frame members adjacent said forward ends of said frame members; and
front wheel rotatably mounted on said forward axle disposed between said frame members.

7. The wheelbarrow as set forth in claim 6, wherein said first and second longitudinal members having a gripping means attached to said second end.

8. The wheelbarrow as set forth in claim 6, wherein said container portion having a parabolically shaped forward perimeter, for directing the load toward the center line of said container when dumping the contents.

9. The wheelbarrow as set forth in claim 6, wherein said wheels each having a friction reducing bearing mean connecting said wheel to said axle to reduce friction between the wheel and frame portion when rotating relative to each other.

10. The wheelbarrow as set forth in claim 6, wherein said longitudinal frame members also having an upward curvature adjacent said rear portion terminus.
